(19) United States
(12) Patent Application Publication
(10) Pub. No.: US 2007/0114436 A1
(43) Pub. Date: May 24, 2007

(54) Filament member, ion source, and ion implantation apparatus

(75) Inventors: Gyeong-Su Keum, Suwon-si (KR); Jai-Hyung Won, Seoul (KR); No-Hyun Huh, Yongin-si (KR); Seong-Gu Kim, Pyeongtaek-si (KR); Kwang-Ho Cha, Yongin-si (KR); Ui-Hui Kwon, Hwaseong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/594,939

(22) Filed: Nov. 9, 2006

(30) Foreign Application Priority Data
Nov. 17, 2005 (KR) 10-2005-0110002

(51) Int. Cl. H01T 23/00

(52) U.S. Cl. 250/423 F

(57) ABSTRACT

A filament member, ion source, and an ion implantation apparatus. The filament member may have a plate shape, and the thermoelectron emitter may include slots and a plurality of conductive paths disposed around the slots to emit thermoelectrons.

### PRIORITY CLAIM

A claim of priority is made under 35 U.S.C. § 119 to Korean Patent Application 2005-110002 filed on Nov. 17, 2005, the entire contents of which are hereby incorporated by reference.

### BACKGROUND

1. Field

The present invention Example embodiments may relate to an apparatus for manufacturing a semiconductor device, and more particularly, to a filament member, an ion source, and an ion implantation apparatus.

2. Description of the Related Art

Ion implantation is a semiconductor device manufacturing process used to dope a silicon wafer with impurities, for example, a P-type dopant, boron (B), aluminum (Al) and indium (In), and a N-type dopant, antimony (Sb), phosphorus (P), and arsenic (As). The impurities may be implanted into the silicon wafer in the form of a plasma ion beam. Ion implantation techniques have been widely used to manufacture semiconductor devices, because controlling the concentration of impurities injected into a wafer may be easier.

An ion implantation apparatus may include an ion source for generating an ion beam. FIG. 1 is a schematic view illustrating a conventional ion source 900. Referring to FIG. 1, the ion source 900 may include an arc chamber 920 and a filament 940 disposed in the arc chamber 920 for emitting thermoelectrons. The arc chamber 920 may include an inlet 922 through which source gas may be introduced and an ion beam outlet 924 through which positive ions may be extracted. When the filament 940 and the arc chamber 920 are powered, the filament 940 may heat-up to a desired temperature to emit electrons. The emitted electrons may collide with gas molecules distributed inside the arc chamber 920 to ionize the gas molecules. During this process, gaseous plasma including various ions and electrons may be generated, and ions may be discharged through the ion beam outlet 924. The generated ions may be emitted through the ion beam outlet 924 and implanted onto a wafer.

Positive ions produced near the filament 940 may be directed to and collide with the filament 940, which may damage the filament surface (sputter etching). The sputter etching may wear the filament 940 and eventually cause a short. In other words, the lifespan of the filament 940 may be shortened due to the sputter etching. The sputter etching may occur at a high rate when positive ions are incident to the filament 940 at an angle of about 30° to 60°. Most of the positive ions hit the filament 940 at an angle, because wire filaments may be commonly used.

As illustrated in FIG. 2, the filament 940 may be formed as a coil to allow electrons to flow in a longer path. In the coil filament, however, thermoelectrons emitted at a rear portion of the filament may collide with a front portion, which may damage the front portion. The damage may shorten the lifespan of the coil filament.

Furthermore, electrons flow through a single path in the wire filament arrangement. Therefore, if the wire filament breaks at any point, for example, by the sputter etching, the operation of an ion implantation apparatus must be stopped to replace the broken wire filament.

In addition, the wire filament may be formed with a tungsten wire by heating the tungsten wire to a high temperature and applying a force to bend the tungsten wire into coil shape, for example, a pig's tail. However, it may be difficult to manufacture the pig's tail shaped coil. Moreover, the characteristic features of tungsten may change when tungsten is heated to a high temperature. The dimension of the pig's tail filament may be easily affected by bending conditions, because the pig's tail filament may be formed by bending. It may also be difficult to manufacture a pig's tail filament having a large diameter.

### SUMMARY

In an example embodiment, a filament member may be configured to discharge thermoelectrons and may include a cathode, an anode, and a thermoelectron emitter disposed between the cathode and the anode. The thermoelectron emitter may be disposed between the cathode and the anode, and the thermoelectron emitter may include slots and a plurality of conductive paths disposed around the slots to emit thermoelectrons.

### BRIEF DESCRIPTION OF THE DRAWINGS

The accompanying drawings, which are included to provide further understanding of example embodiments and are incorporated in and constitute a part of this application, may illustrate example embodiments. In the drawings:

FIG. 1 is a schematic view illustrating a conventional ion source;

FIG. 2 is a perspective view of a filament of the conventional ion source illustrated in FIG. 1;

FIG. 3 illustrates a schematic structure of an ion implantation apparatus according to an example embodiment;

FIG. 4 illustrates a schematic structure of an ion source illustrated in FIG. 3;

FIG. 5 is a perspective view of a filament member illustrated in FIG. 4;

FIG. 6 is a front view of FIG. 5;

FIGS. 7 and 8 are front views of a filament member according to another example embodiment;

FIGS. 9A and 9B illustrate an incident angle of positive ions to a conductive path having a flat front surface and a conductive path having a circular front surface, respectively;

FIG. 10 is a perspective view of a filament member according to another example embodiment;

FIG.11 illustrates traveling paths of ions emitted from the filament member illustrated in FIG. 10 into an arc chamber;

FIG. 12 is a perspective view of a filament member according to another example embodiment; and

FIG. 13 illustrates traveling paths of ions emitted form the filament member illustrated in FIG. 12 into an arc chamber.

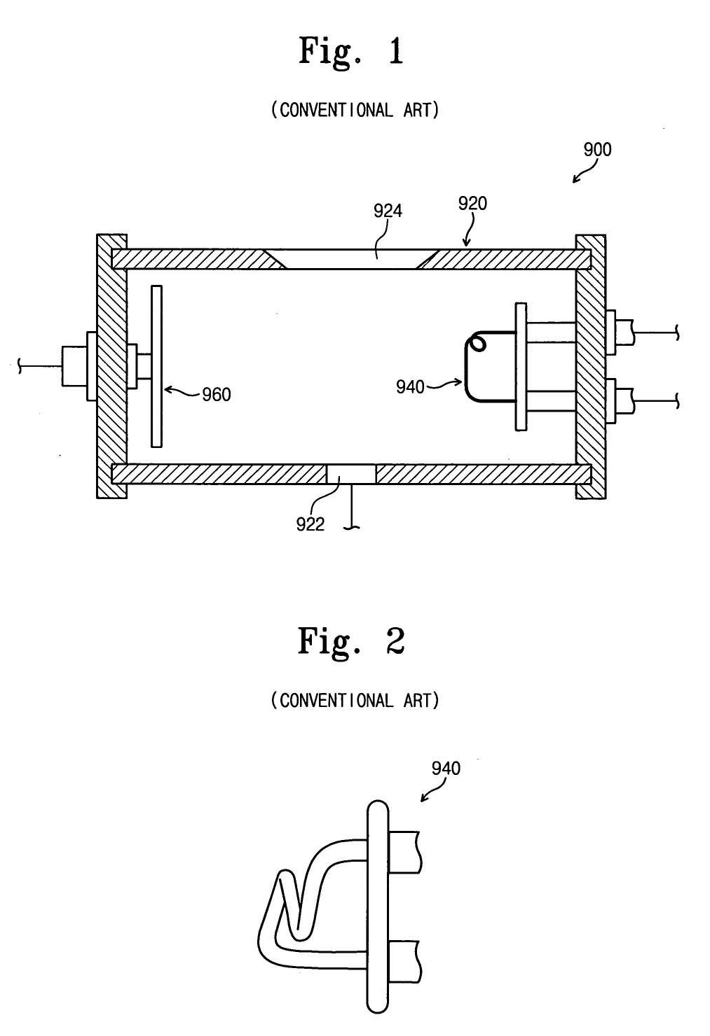

### DETAILED DESCRIPTION OF EXAMPLE EMBODIMENTS

Example embodiments will be described below in more detail with reference to the accompanying drawings. Example embodiments may, however, be embodied in different forms and should not be constructed as limited to example embodiments set forth herein. Rather, example embodiments are provided so that this disclosure will be thorough, and will convey the scope of the example embodiments to those skilled in the art.

It will be understood that when an element or layer is referred to as being “on”, “connected to” or “coupled to” another element or layer, it may be directly on, connected or coupled to the other element or layer or intervening elements or layers may be present. In contrast, when an element is referred to as being “directly on,” “directly connected to” or “directly coupled to” another element or layer, there may be no intervening elements or layers present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms may be only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-section illustrations that may be schematic illustrations of idealized embodiments (and intermediate structures). As such, variations from the shapes of the illustrations as a result, for example, of manufacturing techniques and/or tolerances, are to be expected. Thus, the example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to limit the example embodiments.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

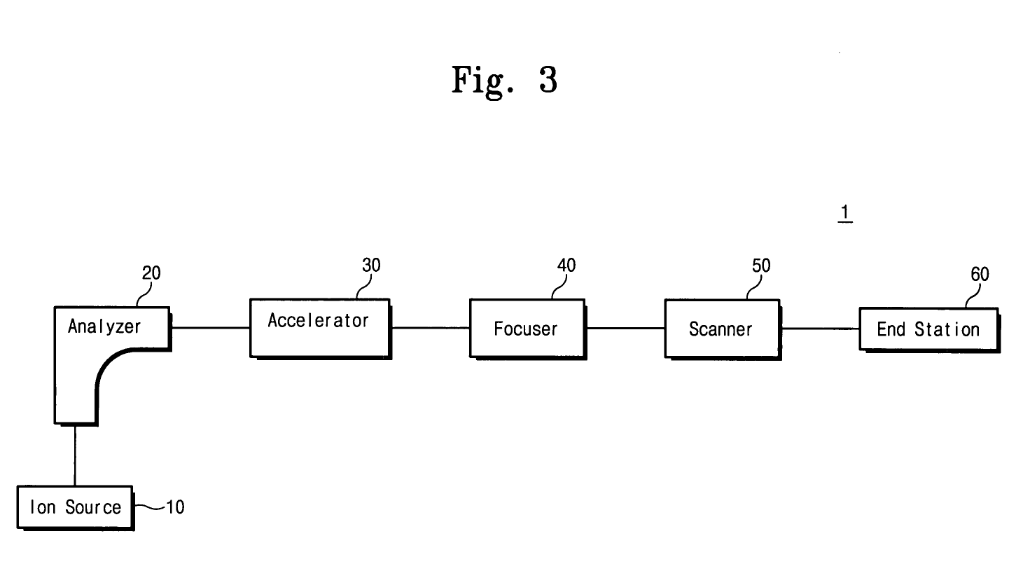

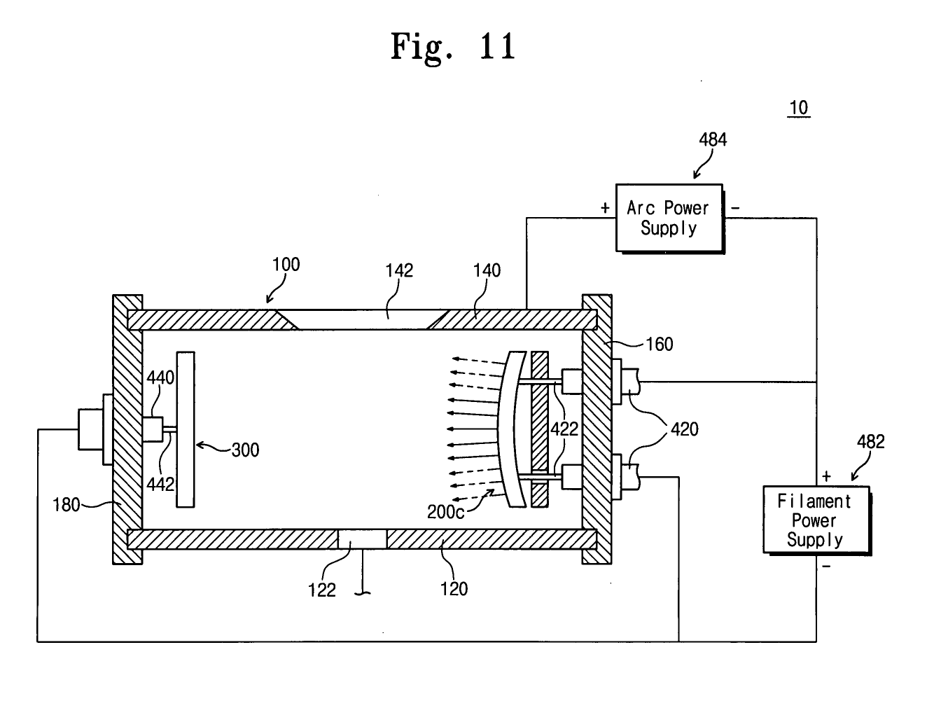

Reference will now be made in detail to example embodiments, with references to FIGS. 3 through 13.

Referring to FIG. 3, an ion implantation apparatus 1 may include an ion source 10, an analyzer 20, an accelerator 30, a concentrator 40, a scanner 50, and an end station 60.

The ion source 10 may produce ions. The analyzer 20 may select specific ions having a desired atomic weight to be implanted into a wafer. The accelerator 30 may accelerate the selected ions to implant the ions to a desired depth on the wafer. When neutral ions ionize and move, positively charged ions may cluster together. Therefore, the ion beam may diverge due to repulsion force of the positively charged ions. Thus, the concentrator 40 may focus the ion beam to a scanner 50. The scanner 50 may vary the direction of the ion beam to all directions to uniformly scan the wafer. The ions may be implanted into the wafer at the end station 60.

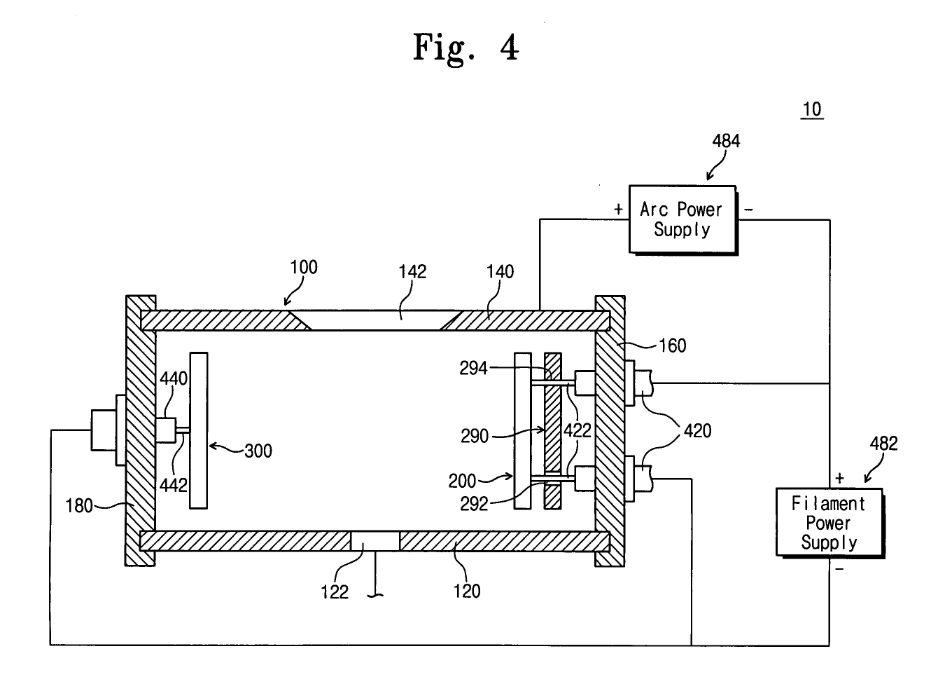

FIG. 4 is a sectional view of the ion source 10 of the ion implantation apparatus 1 illustrated in FIG. 3. Referring to FIG. 4, the ion source 10 may include an arc chamber 100, a filament member 200, and a repeller 300.

The arc chamber 100 may have a substantially rectangular shape with a first sidewall 120, a second sidewall 140, a third sidewall 160, a fourth sidewall 180, a fifth sidewall (not shown), and a sixth sidewall (not shown). The first and second sidewalls 120 and 140 may face each other, and the third and fourth sidewalls 160 and 180 may face each other. The third and fourth sidewalls 160 and 180 may be perpendicular to the first and second sidewalls 120 and 140. The first sidewall 120 of the arc chamber 100 maybe formed with an inlet 122 for introducing source gas. The second sidewall 140 of the arc chamber 100 may be formed with an ion beam outlet 142 for extracting positively charged ions produced inside the arc chamber 100. The inlet 122 may be a circular hole, and the ion beam outlet 142 may have a slit shape. The arc chamber 100 may receive a positive voltage from an arc power supply 484.

The filament member 200 and the repeller 300 may be installed in the arc chamber 100. The filament member 200 may be near and in parallel with the third sidewall 160, and the repeller 300 may be near and in parallel with the fourth sidewall 180. The filament member 200 may emit thermoelectrons to separate the source gas into positively charged ions and electrons.

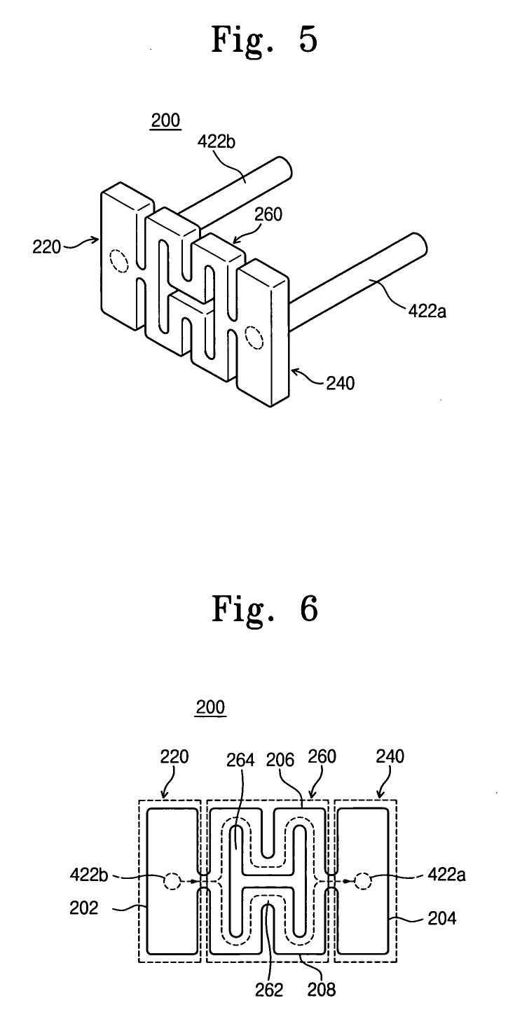

The repeller 300 may receive a negative voltage. Thermoelectrons emitted from the filament member 200 that do not ionize with the source gas may be pushed back to the source gas by the repeller 300. The filament member 200 may be supported by filament fixing blocks 420, and the repeller 300 may be supported by a repeller fixing block 440. The filament fixing blocks 420 may penetrate through the third sidewall 160. The filament fixing block 420 may be formed of an insulating material in order to support the filament member 200 and insulate the filament member 200 from the arc chamber 100. Conductive projections 422 (denoted by reference numerals 422a and 422b in FIG. 5) may be connected to the filament member 200 and inserted into the filament fixing block 420. The conductive projections 422 may receive a filament current from a filament power supply 482. The repeller fixing block 440 may penetrate the fourth sidewall 180 of the arc chamber 100. The repeller fixing block 440 may support the repeller 300 and insulate the repeller 300 from the arc chamber 100. A conductive projection 442 may be connected to the repeller 300 and inserted into the repeller fixing block 440.

Referring to FIGS. 4, 5, and 6, a cathode plate 290 may be disposed between the filament member 200 and the third sidewall 160. The cathode plate 290 may push thermoelectrons emitted from conductive paths 262 of the filament member 200 toward the source gas (e.g., toward the fourth sidewall 180). The cathode plate 290 may include holes 292 and 294. The hole 292 may receive the conductive projection 422a coupled to an anode 220 of the filament member 200, and the hole 294 may receive the conductive projection 422b coupled to a cathode 240 of the filament member 200. The hole 292 may be sufficiently large such that the conductive projection 422a coupled to the anode 220 does not make contact with the cathode plate 290. The hole 294 may be of size such that the conductive projection 422b coupled to the cathode 240 contacts the cathode plate 290.

With reference to FIGS. 5 and 6, the filament member 200 will now be described. FIG. 5 is a perspective view of the filament member 200, and FIG. 6 is a front view of FIG. 5. The filament member 200 may include the anode 220, the cathode 240, and a thermoelectron emitter 260.

A positive terminal of the filament power supply 482 may be connected to the conductive projection 422a, and the anode may be connected to the conductive projection 422a. A negative terminal of the filament power supply 482 may be connected to the conductive projection 422b, and the conductive projection 422b may be connected to the anode 220. The thermoelectron emitter 260 may include the conductive paths 262. The conductive paths 262 may have one end connected to the anode 220 and the other end connected to the cathode 240. Electrons may flow from the cathode 240 to the anode 220 through the conductive paths 262. A current of about 200 amps may be applied to the conductive paths 262, and thermoelectrons may be emitted from the conductive paths 262 due to heat generated by the current.

In an example embodiment, the thermoelectron emitter 260 may include at least two conductive paths 262. Each of the conductive paths 262 may be sufficiently narrow such that thermoelectrons may be emitted. However, the conductive paths 262 may break if the conductive paths 262 are too narrow, therefore, the width of the conductive paths 262 should be accordingly considered. Further, each of the conductive paths 262 should be of sufficient length to emit thermoelectrons. Each of the conductive paths 262 may also be formed into a zigzag shape, such that each of the conductive paths 262 may have a longer length in a limited region in the thermoelectron emitter 260. The zigzag configured conductive paths 262 may be formed by defined plate slots 264 as illustrated in FIG. 6. Die casting, electrical discharge machining, or wire cutting may be used to form the plate slots 264 in a tungsten plate.

The conductive paths 262 may have the same shape with respect to each other. If the conductive paths 262 have different shapes, the conductive paths 262 may have different resistances, resulting in different currents flowing through the conductive paths 262. In this case, the conductive paths 262 may emit different amount of thermoelectrons, and thus thermoelectron emission rates may vary across the thermoelectron emitter 260.

In an example embodiment, as shown in FIG. 6, the filament member 200 may have a rectangular plate shape with a first side 202, a second side 204, a third side 206, and a fourth side 208. The first and second sides 202 and 204 may face each other, and the third and fourth sides 206 and 208 may face each other. The anode 220 may be disposed on the first side 202, the cathode 240 may be disposed on the second side 204, and the thermoelectron emitter 260 may be formed between the anode 220 and the cathode 240. The plate slots 264 may be formed in the thermoelectron emitter 260 between the anode 220 cathode 240. For example, one of the plate slots 264 may be formed inwardly from the third side 206 between the anode 220 and the thermoelectron emitter 260 in a direction parallel with the first side 202. Further, another of the plate slots 264 may be formed inwardly from the fourth side 208 between the anode 220 and the thermoelectron emitter 260 in a direction parallel with the first side 202. In other words, the plate slots 264 may form an “H” shape in the thermoelectron emitter 260. These plate slots 264, formed from the third side 206 and the fourth side 208, may have the same length and face each other. In the same way, some of the other plate slots 264 may be formed between the cathode area 240 and the thermoelectron emitting area 260.

By forming the plate slots 264 in a configuration as described above, the thermoelectron emitter 260 may include the two conductive paths 262 symmetrically formed on upper and lower sides therein, and each of the two conductive paths 262 may have a zigzag shape. Specifically, the zigzag shape of each of the conductive paths 262 may be configured using first paths arranged in parallel and a second path arranged perpendicular and connected to the first paths. The plate slots 264 may be formed such that each of the conductive paths 262 may have a uniform width throughout its length.

In the above-described example embodiment, the conductive paths 262 may be symmetric with respect to each other. However, the conductive paths 262 do not have to be symmetric with respect to each other. The conductive paths 262 may have the same width and length. Thus, the conductive paths 262 may have similar resistances. The conductive paths 262 may have other shapes, for example, a straight or curved shape.

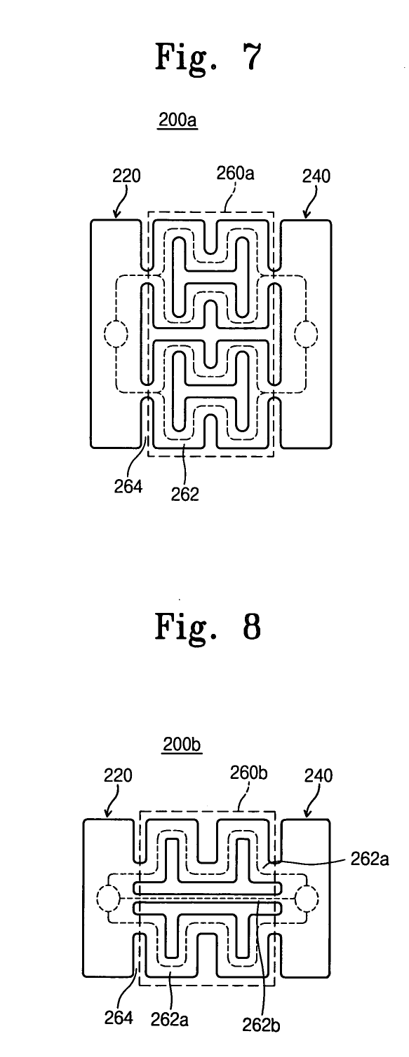

In the above-described example embodiment, the thermoelectron emitter 260 may include two conductive paths 262. However, in another example embodiment, a filament member 200a may include a thermoelectron emitter 260a configured with more than two conductive paths 262, as illustrated in FIG. 7.

In another example embodiment illustrated in FIG. 8, a filament member 200b may include a thermoelectron emitter 260 configured with conductive paths 262a and 262b having different widths and lengths. In this case, the conductive paths 262a and 262b may have different resistances. For example, the thermoelectron emitting area 260b may include two symmetrical zigzag conductive paths 262a and one relatively straight conductive path 262b. Thermoelectrons emitted from the straight conductive path 262b may be more intensive than the two symmetrical zigzag conductive paths 262a, because the straight conductive path 260b may have a relatively smaller resistance. As the thermoelectrons are emitted, the straight conductive path 262b may become narrower and thus the resistance of the straight conductive path 262b may increase. Therefore, after a time, the resistance of the zigzag conductive paths 262a may become smaller than that of the straight conductive path 262b, and thermoelectrons emitted from the zigzag conductive path 262a may be more intensive than from the straight conductive path 262b. This thermoelectron emitting pattern may repeat. Although the thermoelectron emitting rate of the conductive paths 262a and 262b are at times different, the average thermoelectron emitting rate of the conductive paths 262a and 262b may be similar over a period of time. Thus, the life span of the conductive paths 262a and 262b may be similar.

As illustrated in FIG. 8, the cathode 240 and the anode 220 may be connected by the plurality of conductive paths 262a and 262b. Therefore, even if one of the conductive paths 262a and 262b breaks, the filament member 200b may function until all the conductive paths are broken.

Referring again to FIG. 5, the filament member 200 may be formed of a relatively flat plate such that thermoelectrons may be emitted from a flat surface of the filament member 200 onto gases in the arc chamber 100. When positive ions generated near the conductive paths 262 collide onto the conductive paths 262, most of the positive ions may be incident at a right angle to the conductive paths 262. Therefore, damage by the positive ions (sputter etching) may be reduced.

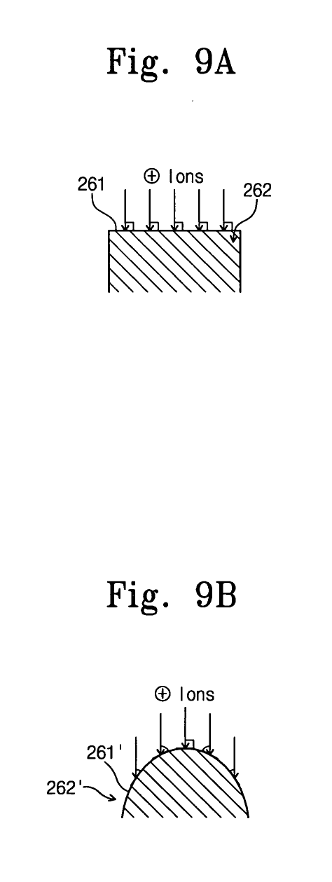

FIG. 9A illustrates the incident angle of positive ions to a conductive path 262 having a flat front surface 261, and FIG. 9B illustrates the incident angle of positive ions to a conductive path 262′ having a circular front surface 261′. Referring to FIG. 9B, because positive ions may collide onto the circular front surface 261′ of the conductive path 262′, most of the positive ions may be incident on the circular surface 261′ at non-perpendicular angles. Therefore, sputter etching rate may be high. However, referring to FIG. 9A, positive ions may collide onto the flat front surface 261 of the conductive path 262. Therefore, most of the positive ions may be incident on the flat front surface 261 at a right angle, and thus sputter etching rate may be lower.

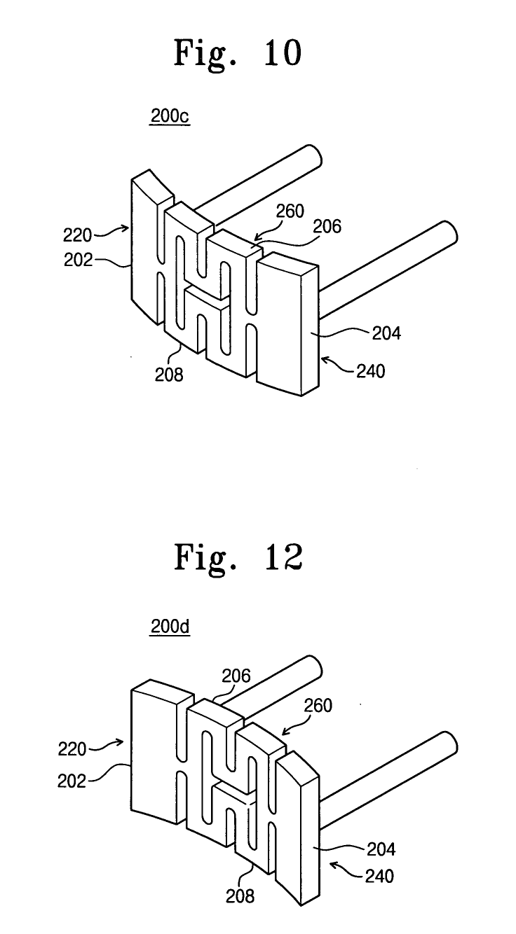

FIG. 10 is a perspective view of a filament member 200c according to another example embodiment. Referring to FIG. 10, a filament member 200c may be formed of a convex plate. The convex plate may include a first side 202, a second side 204, and a convex surface formed between the first side 202 and the second side 204. Thermoelectrons may be emitted from the convex surface toward gases in the arc chamber 100 Referring to FIG. 10, when the filament member 200c shown in FIG. 10 is used as compared with a flat filament, thermoelectrons may be emitted to a wider area. The convex plate may have a sufficiently large radius of curvature to reduce a sputter etching rate. Alternatively, the filament member 200c may curve convexly from its four sides 202, 204, 206, and 208 toward the center thereof.

FIG. 12 is a perspective view of a filament member 200d according to another example embodiment. Referring to FIG. 12, the filament member 200d may be formed of a concave plate. The concave plate may include a first side 202, a second side 204, and a concave surface formed between the first side 202 and the second side 204.

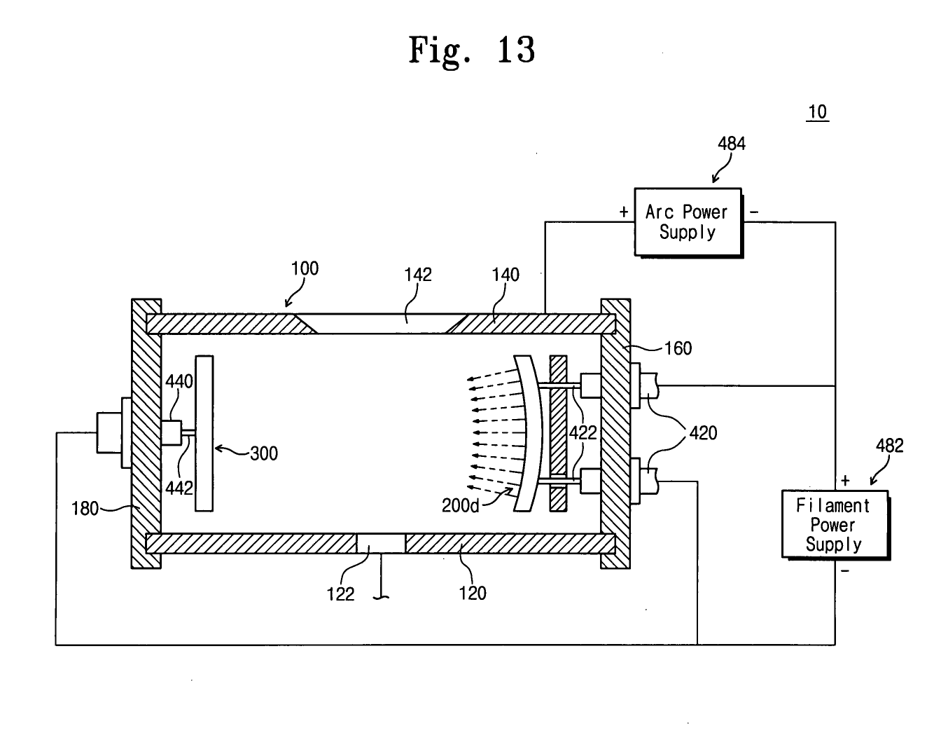

Thermoelectrons may be emitted from the concave surface toward gases in the arc chamber 100. Referring to FIG. 13, when the filament member 200d illustrated in FIG. 12 is used, thermoelectrons emitted from the filament member 200d may converge to a narrower area in the arc chamber 100. The concave plate may have a sufficiently large radius of curvature to reduce sputter etching rate. Alternatively, the filament member 200d may curve concavely from its four sides 202, 204, 206, and 208 toward the center of the arch chamber 100.

In example embodiments, as illustrated in FIGS. 5-8, 10 and 12, an anode and at least one of a first conductive path and/or a cathode and at least one of a second conductive path are coplanar; that is a plane exists in a direction substantially parallel to a major axis of a filament member that cuts through the anode and at least one of the conductive paths and/or the cathode and at least one of the second conductive paths.

In the above-described example embodiments, the filament member may have a rectangular plate shape. However, the filament member may have other shapes, for example, a circular plate shape, a polygon plate shape, etc.

According to the filament member of example embodiments, conductive paths may be provided by forming slots in a tungsten plate. Therefore, conductive paths having various shapes and widths may be provided.

Further, since the filament member may include a plurality of conductive paths, the filament member may continuously be used even when one of the conductive paths is shorted. Therefore, the lifespan of the filament member can be increased.

Furthermore, when the filament member may be formed of a flat plate according to example embodiments, sputter etching caused by positive ions colliding into the filament member may be reduced. Therefore, the lifespan of the filament member may increase.

In addition, when the filament member may be formed of a convex plate according to another embodiment, thermoelectrons may be emitted from the filament member to a wide area in an arc chamber. Therefore, the thermoelectrons may ionize gases throughout the arc chamber.

Further, when the filament member may be formed of a concave plate according to a further another example embodiment, thermoelectrons emitted from the filament member may converge on an area of an arc chamber. Therefore, the ionization of gases in the arc chamber may increase at the area.

It will be apparent to those skilled in the art that various modifications and variations may be made in example embodiments. Thus, it is intended that example embodiments may cover the modifications and variations provided they come within the scope of the appended claims and their equivalents.

What is claimed is:

1. A filament member, comprising:
a cathode;
an anode; and
a thermoelectron emitter disposed between the cathode and the anode, and the thermoelectron emitter including slots and a plurality of conductive paths disposed around the slots to emit thermoelectrons.

2. The filament member of claim 1, wherein each of the plurality of conductive paths have the same width and length.

3. The filament member of claim 1, wherein each of the plurality of conductive paths form a zigzag shape.

4. The filament member of claim 1, wherein a shape of the filament member is rectangular plate.

5. The filament member of claim 1, wherein a shape of the filament member is one of a circular or polygonal plate.

6. The filament member of claim 1, wherein the filament member has a flat surface.

7. The filament member of claim 1, wherein the filament member has a convex or concave surface.

8. The filament member as set forth in claim 1, wherein at least two of the cathode, the anode, and the at least one conductive path are coplanar.

9. The filament member of claim 1, wherein the plurality of conductive paths includes an even number of conductive paths, and each pair of the even number of paths is symmetrical with respect to each other.

10. The filament member of claim 1, wherein the plurality of conductive paths includes an odd number of conductive paths, and a length of each of the odd number of paths is different with respect to each other.

11. The filament member of claim 1, wherein the filament member is formed of tungsten.

12. The filament member of claim 1, wherein the slots are symmetrical about the center of the filament member.

13. An ion source comprising:
the filament member of claim 1;
an arc chamber including an inflow port configured to introduce source gas and a beam outlet configured to externally emit ions generated in the arc chamber;
an arc power supply to supply power to the arc chamber; and
a filament power source to supply power to the filament member.

14. The ion source of claim 13, wherein the arc chamber includes a repeller disposed on an opposite side of the filament member.

15. The ion source of claim 13, wherein the arc chamber includes a negative conductive projection connected to the cathode, and a positive conductive projection connected to the anode.

16. An ion implantation apparatus comprising:
the ion source of claim 13;
an analyzer configured to select ions from the ion source; and
an accelerator configured to accelerate the selected ions into a wafer.

17. The ion implantation apparatus of claim 16, wherein the ion implantation apparatus further comprises:
a concentrator configured to preventing the selected ions from spreading;
a scanner configured to control a vertical direction of the selected ions; and
an end station configured to hold the wafer for ion injection.
